(19) United States
(12) Patent Application Publication
(10) Pub. No.: US 2016/0314164 A1
(43) Pub. Date: Oct. 27, 2016

(54) METHODS AND DEVICES FOR SHARING CLOUD-BASED BUSINESS CARD

(71) Applicant: Xiaomi Inc., Beijing (CN)

(72) Inventors: Kun Niu, Beijing (CN); Xiehao Bao, Beijing (CN); Zhenhai ZHAO, Beijing (CN)

(21) Appl. No.: 15/076,608

(22) Filed: Mar. 21, 2016

(30) Foreign Application Priority Data
Apr. 27, 2015 (CN) 201510205370.3

(51) Int. Cl. G06F 17/30; G06Q 10/10

(52) U.S. Cl. CPC G06F 17/30368; G06F 17/30371; G06Q 10/10

(57) ABSTRACT

A method for sharing a cloud-based business card includes receiving business card data of a first user from a first terminal device. Herein the business card data carrying a user identifer of the first user. The method further includes performing a search to determine whether a digital business card of the first user has been stored in the cloud server by using the user identifer of the first user; updating the digital business card of the first user according to the business card data of the first user to obtain an updated digital business card of the first user in response to determing that a digital business card of the first user has been stored in the cloud server; and sending the updated digital business card of the first user to a second terminal device which has stored the user identifer of the first user.

### CROSS-REFERENCE TO RELATED APPLICATIONS

The present application is based upon and claims priority to Chinese Patent Application No. 201510205370.3, filed Apr. 27, 2015, the entire contents of which are incorporated herein by reference.

### TECHNICAL FIELD

The present disclosure generally relates to the field of network communication technology, and more particularly, to methods and devices for sharing a cloud-based business card.

### BACKGROUND

With the continuous development of network communication technology, conventional electronic business cards have been gradually replaced by cloud-based digital business cards. A cloud-based digital business card is an electronic business card created by a user and stored in a cloud server. In the related art, after a user uploads digital business cards, he can manage the digital business cards, for example, classifying the digital business cards, sorting the digital business cards, fast searching the digital business cards, sharing the digital business cards with his friends and setting a timely reminding function. However, after a digital business card of a user is updated, it is hardly possible for a contact of the user to quickly identify the cloud-based digital business card of the user, resulting in a poor user experience.

### SUMMARY

According to a first aspect of embodiments of the present disclosure, there is provided a method for sharing a cloud-based business card, which is implemented by a cloud server. The method includes: receiving business card data of a first user from a first terminal device, the business card data carrying a user identifer of the first user; performing a search to determine whether a digital business card of the first user has been stored in the cloud server by using the user identifer of the first user; updating the digital business card of the first user according to the business card data of the first user to obtain an updated digital business card of the first user in response to determing that a digital business card of the first user has been stored in the cloud server; and sending the updated digital business card of the first user to a second terminal device which has stored the user identifer of the first user, such that when a second user communicates with the first user by utilizing the second terminal device, the second terminal device automatically displays the updated digital business card of the first user to make the second user identify the first user based on the updated digital business card of the first user.

According to a second aspect of embodiments of the present disclosure, there is provided a cloud server for sharing a cloud-based business card. The cloud server includes: a processor; and a memory for storing instructions executable by the processor; wherein the processor is configured to perform: receiving business card data of a first user from a first terminal device, the business card data carrying a user identifer of the first user; performing a search to determine whether a digital business card of the first user has been stored in the cloud server by using the user identifer of the first user; updating the digital business card of the first user according to the business card data of the first user to obtain an updated digital business card of the first user in response to determing that a digital business card of the first user has been stored in the cloud server; and sending the updated digital business card of the first user to a second terminal device which has stored the user identifer of the first user, such that when a second user communicates with the first user by utilizing the second terminal device, the second terminal device automatically displays the updated digital business card of the first user to make the second user identify the first user based on the updated digital business card of the first user.

According to a third aspect of embodiments of the present disclosure, there is provided a non-transitory computer-readable storage medium storing instructions that, when being executed by a processor of a cloud server, for performing a method for sharing a cloud-based business card. The method includes: receiving business card data of a first user from a first terminal device, the business card data carrying a user identifer of the first user; performing a search to determine whether a digital business card of the first user has been stored in the cloud server by using the user identifer of the first user; updating the digital business card of the first user according to the business card data of the first user to obtain an updated digital business card of the first user in response to determing that a digital business card of the first user has been stored in the cloud server; and sending the updated digital business card of the first user to a second terminal device which has stored the user identifer of the first user, such that when a second user communicates with the first user by utilizing the second terminal device, the second terminal device automatically displays the updated digital business card of the first user to make the second user identify the first user based on the updated digital business card of the first user.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart illustrating a method for sharing a cloud-based business card according to an exemplary embodiment of the present disclosure;

FIG. 2 is a flow chart illustrating another method for sharing a cloud-based business card according to an exemplary embodiment of the present disclosure;

FIG. 3 is a flow chart illustrating another method for sharing a cloud-based business card according to an exemplary embodiment of the present disclosure;

FIG. 4 is a flow chart illustrating another method for sharing a cloud-based business card according to an exemplary embodiment of the present disclosure;

FIG. 5 is a flow chart illustrating another method for sharing a cloud-based business card according to an exemplary embodiment of the present disclosure;

FIG. 6 is a diagram illustrating an application scenario of a method for sharing a cloud-based business card according to an exemplary embodiment of the present disclosure;

FIG. 7 is a block diagram illustrating a device for sharing a cloud-based business card according to an exemplary embodiment of the present disclosure;

FIG. 8 is a block diagram illustrating another device for sharing a cloud-based business card according to an exemplary embodiment of the present disclosure;

FIG. 9 is a block diagram illustrating another device for sharing a cloud-based business card according to an exemplary embodiment of the present disclosure;

FIG. 10 is a block diagram illustrating another device for sharing a cloud-based business card according to an exemplary embodiment of the present disclosure;

FIG. 11 is a block diagram illustrating another device for sharing a cloud-based business card according to an exemplary embodiment of the present disclosure;

FIG. 12 is a block diagram illustrating another device for sharing a cloud-based business card according to an exemplary embodiment of the present disclosure; and

FIG. 13 is another block diagram illustrating another device for sharing a cloud-based business card according to an exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

The terms used herein are merely for describing a particular embodiment, rather than limiting the present disclosure. As used in the present disclosure and the appended claims, terms in singular form such as “a”, “said” and “the” are intended to also include plural forms, unless explicitly dictated otherwise. It should also be understood that the term “and/or” used herein means any one or any possible combination of one or more associated listed items.

It should be understood that, although it may describe an element with a term first, second, or third, etc., the element is not limited by these terms. These terms are merely for distinguishing among elements of the same kind. For example, without departing from the scope of the present disclosure, a first element can also be referred to as a second element. Similarly, a second element can also be referred to as a first element. Depending on the context, a term “if” as used herein can be interpreted as “when”, “where” or “in response to”.

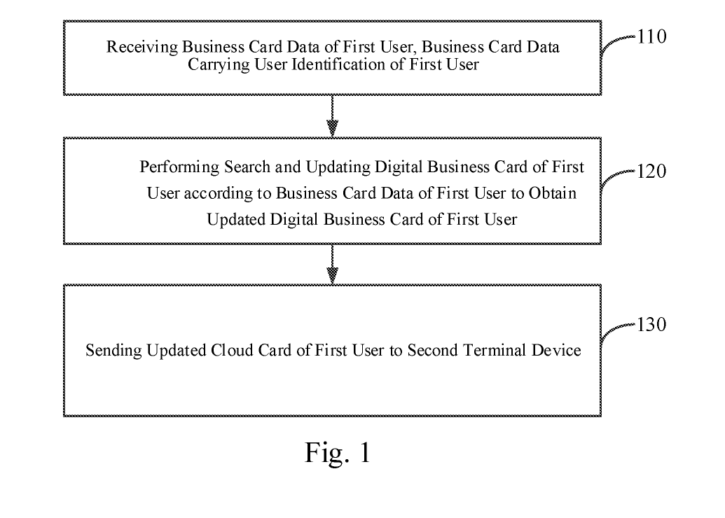

FIG. 1 is a flow chart illustrating a method for sharing a cloud-based business card according to an exemplary embodiment of the present disclosure, which is implemented by a cloud server. The method includes the following steps.

In step 110, business card data of a first user is received. Herein the business card data carries a user identifer of the first user. For example, the business card data of the first user can be previously sent to the cloud server through a first terminal device by the first user.

In the embodiment of the present disclosure, the received business card data can include initial data for a digital business card which is originally created by the first user. Alternatively, the received business card data can include new business card data for updating the original digital business card. For example, the digital business card can be an electronic business card created by the first user and stored in the cloud server. After the first user uploads the digital business card, the server can manage the digital business card of the first user. For example, assuming that the first user is a user A, the digital business card of the user A contains a name, a mobile phone number, a portrait and the like of the user A.

In addition, the user identifer of the first user can be a user name registered in the cloud server by the first user, or can be a mobile phone number or the like of the first user. The user identifer is used by the cloud server to search out a digital business card of the first user by using the user identifer as a key word or index.

In step 120, a search is performed to determine whether a digital business card of the first user has been stored in the cloud server by using the user identifer of the first user. Moreover, the digital business card of the first user is updated according to the business card data of the first user to obtain an updated digital business card of the first user in response to determing that a digital business card of the first user has been stored in the cloud server.

In the embodiment of the present disclosure, when a digital business card of the first user is searched out according to the user identifer of the first user, it means the cloud server has stored the digital business card of the first user, and the currently received business card data of the first user is used to update the existing digital business card by the first user.

For example, when the first user wants to update a portrait of the existing digital business card, the first terminal device sends the business card data of the first user to the cloud server. The business card data of the first user received by the cloud server contains a replacement portrait of the first user, so the cloud server updates the portrait in the digital business card of the first user which is stored locally in the cloud server with the replacement portrait. Then, the updated digital business card contains the most recent portrait of the first user.

For another example, when the first user wants to update the existing mobile phone number in the digital business card or add a new mobile phone number, the first terminal device sends the business card data of the first user to the cloud server. The business card data of the first user received by the cloud server contains a replacement mobile phone number or a new mobile phone number to be added, so the cloud server updates the mobile phone number in the digital business card of the first user which is stored locally in the cloud server with the replacement mobile phone number or the new mobile phone number to be added. Then, the updated digital business card contains the updated mobile phone number of the first user or the new mobile phone number to be added.

In step 130, the updated digital business card of the first user is sent to a second terminal device which has stored the user identifer of the first user, such that when a second user communicates with the first user by utilizing the second terminal device, the second terminal device automatically displays the updated digital business card of the first user to make the second user identify the first user based on the updated digital business card of the first user.

In the embodiment of the present disclosure, the second user can be a user who has stored the user identifer of the first user in a terminal device owned by the second user (the terminal device owned by the second user will be referred as “the second terminal device”). For example, the first user is a contact of the second user and is recorded in a contact book application program installed in the second terminal device. For example, if the first user has created a cloud-based digital business card of the first user, the cloud server will send the digital business card of the first user to the second terminal device corresponding to the second user and store it in the contact book application program of the second terminal device. If the first user wants to update his cloud-based digital business card, the cloud server will update the digital business card stored in the cloud server according to the updated business card data of the first user to obtain an updated digital business card. At the meantime, the digital business card of the first user in the contact book application program installed in the second terminal device will be automatically updated by the cloud server.

For example, assuming that the first user is a user A and the second user is a user B, when the user A calls the user B with an updated mobile phone number or an added new mobile phone number, the second terminal device used by the user B will display the most recent digital business card of the user A in a call receiving interface. Alternatively, when the user A sends a short message to the user B with an updated mobile phone number or an added new mobile phone number, the second terminal device used by the user B will display the most recent digital business card of the user A in a short message interface.

It can be seen from the above embodiment that, after it receives the business card data of the first user, the cloud server can automatically update the digital business card of the first user according to the business card data, and send the updated digital business card to the second user, such that the second user can automatically update the digital business card of the first user and when the first user communicates with the second user, the second user can automatically identify the first user. Thereby, it can improve the speed and accuracy of the identification of the first user by the second user, and can improve the user experience for the second user.

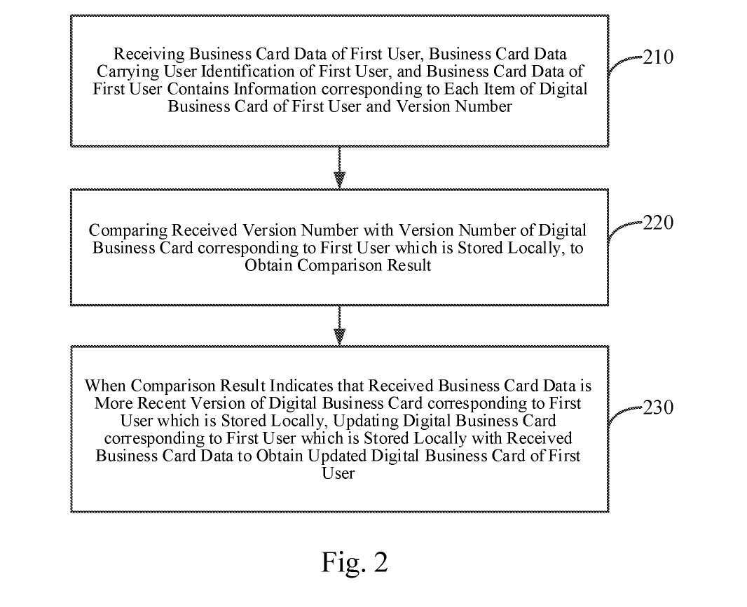

FIG. 2 is a flow chart illustrating another method for sharing a cloud-based business card according to an exemplary embodiment of the present disclosure, which is implemented by a cloud server. Based on the embodiment as shown in FIG. 1, the method includes the following steps.

In step 210, business card data of the first user is received. Herein the business card data of the first user carries a user identifer of the first user. And the business card data of the first user can contain information corresponding to each item of the digital business card of the first user and a version number.

In step 220, the received version number is compared with a version number of a digital business card of the first user which is stored locally, to obtain a comparison result.

For example, assuming that the first user is a user A, the digital business card of the user A stored in the cloud server contains a name, a mobile phone number 1, a portrait 1 and the like of the user A, and the version number is 1. When the user A wants to update the mobile phone number 1 with a mobile phone number 2, and update the portrait 1 with a portrait 2, the business card data of the first user which is received by the cloud server contains the name of the user A, the telephone number 2, the portrait 2 and the version number is 2. The cloud server compares the received version number 2 with the version number 1, to obtain a comparison result that the digital business card corresponding to the version number 2 is a more recent version of the digital business card corresponding to the version number 1.

In step 230, when the comparison result indicates that the received business card data is a more recent version of the digital business card of the first user which is stored locally, the digital business card of the first user which is stored locally is updated with the received business card data to obtain the updated digital business card of the first user.

In addition, when the comparison result indicates that received business card data is not a more recent version of the digital business card of the first user previously stored in the cloud server, the digital business card is not updated.

In can be seen from the above embodiment that, after the cloud server receives the business card data of the first user, if the business card data contains information corresponding to each item of the digital business card of the first user and a version number, the cloud server can directly determine whether to update the stored digital business card of the first user according to the version number. If it is determined to update the digital business card, the stored digital business card of the first user can be directly replaced with the received business card data. Thereby, the update speed of the cloud server can be relatively fast.

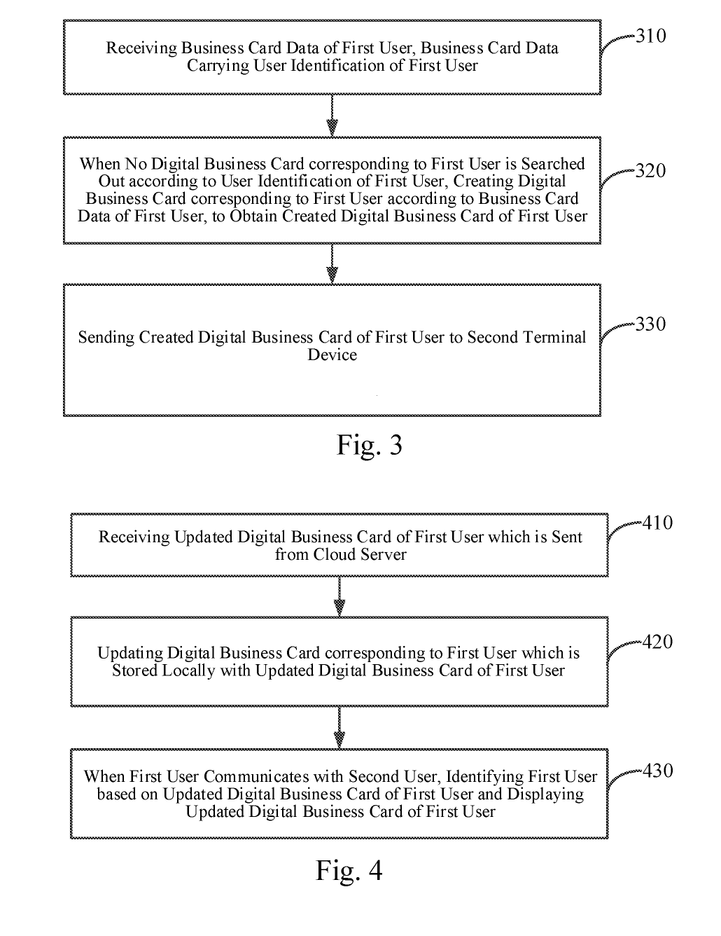

FIG. 3 is a flow chart illustrating another method for sharing a cloud-based business card according to an exemplary embodiment of the present disclosure, which is implemented by a cloud server. Based on the embodiment as shown in FIG. 1, the method includes the following steps.

In step 310, business card data of a first user is received. Herein the business card data carries a user identifer of the first user.

In the embodiment of the present disclosure, business card data can include initial data for a cloud-based a digital business card originally created by the first user. After the first user uploads the business card data, the cloud server can create a cloud-based digital business card of the first user according to the business card data. For example, assuming that the first user is a user A, the digital business card of the user A contains a name, a mobile phone number, a portrait and the like of the user A.

In step 320, when no digital business card of the first user has been stored in the cloud server, a digital business card of the first user is created according to the business card data of the first user, to obtain a created digital business card of the first user.

In the embodiment of the present disclosure, when a search is performed by using the user identifer of the first user and no digital business card of the first user is searched out, it means that the cloud server has not created and stored a digital business card of the first user, therefore it can create a digital business card of the first user according to the received business card data of the first user.

In step 330, the created digital business card of the first user is sent to a second terminal device which has stored the user identifer of the first user, such that when a second user communicates with the first user by utilizing the second terminal device, the second terminal device automatically displays the created digital business card of the first user to make the second user identify the first user based on the created digital business card of the first user.

In the embodiment of the present disclosure, the second terminal device is owned by the second user and has stored the user identifer of the first user. For example, the first user is a contact of the second user and is recorded in a contact book application program of the second terminal device. If the first user has created a digital business card of the first user, the cloud server will send the digital business card of the first user to a second terminal device corresponding to the second user and store it in the contact book application program of the second terminal device. Then, when the first user communicates with the second user, the second terminal device can display the created digital business card of the first user such that the second user can identify the first user based on the created digital business card of the first user.

It can be seen from the above embodiment that, after the cloud server receives the business card data of the first user, when it has not created a digital business card of the first user, the server will create a digital business card of the first user according to the received data and send the created digital business card to the second user. Then the second terminal device can store the digital business card of the first user. When the first user communicates with the second user, the second user can automatically identify the first user. Thereby, it can improve the speed and accuracy of the identification of the first user by the second user, and can improve the user experience for the second user.

In addition, in the above method for sharing a cloud-based business card as shown in FIGS. 1 to 4, the first user can communicate with the second user through at least one of the following communication manners.

First Manner: the first user calls the second user with an updated telephone number.

Second Manner: the first user sends a short message to the second user with an updated telephone number.

Third Manner: the first user sends an email to the second user with an updated email address.

Herein, the updated telephone number and the updated email address can be contained in the business card data of the first user.

FIG. 4 is a flow chart illustrating another method for sharing a cloud-based business card according to an exemplary embodiment of the present disclosure, which is implemented by a second terminal device which is used by a second user. The method includes the following steps.

In step 410, an updated digital business card of a first user which is sent from a cloud server is received.

In the embodiment of the present disclosure, the first user can be a contact of the second user and the contact information of the first user is recorded in a contact book application program installed in the second terminal device. If the first user wants to update his cloud-based digital business card, the cloud server will update the digital business card according to the updated business card data of the first user to obtain an updated digital business card. At the meantime, the digital business card of the first user in the contact book application program of the second terminal device will be automatically updated by the cloud server.

In step 420, a digital business card of the first user which is stored locally in the second terminal device is updated with the updated digital business card of the first user.

In step 430, when the first user communicates with a second user which has stored a user identifer of the first user, the first user is identified based on the updated digital business card of the first user and the updated digital business card of the first user is displayed.

For example, assuming that the first user is a user A and the second user is a user B, when the user A calls the user B with the updated mobile phone number or the added new mobile phone number, the second terminal device used by the user B will display the most recent digital business card of the user A in a call receiving interface. Alternatively, when the user A sends a short message to the user B with an updated mobile phone number or an added new mobile phone number, the second terminal device used by the user B will display the most recent digital business card of the user A in a short message interface. Thereby, the second user can identify the first user more quickly, resulting in an improved user experience for the second user.

It can be seen from the above embodiment that, after the second terminal device receives the updated digital business card of the first user (the first user is a contact of the second user corresponding to the second terminal device) which is sent from the server, the second terminal device can automatically update the digital business card of the first user which is stored locally in the second terminal device with the updated digital business card of the first user. Then, when the first user communicates with the second user, the second terminal device can identify the first user based on the updated cloud data of the first user and display the updated digital business card of the first user. Thereby, the second user can automatically identify the first user based on the updated digital business card of the first user. Thus, it can improve the speed and accuracy of the identification of the first user by the second user, and can improve the user experience for the second user.

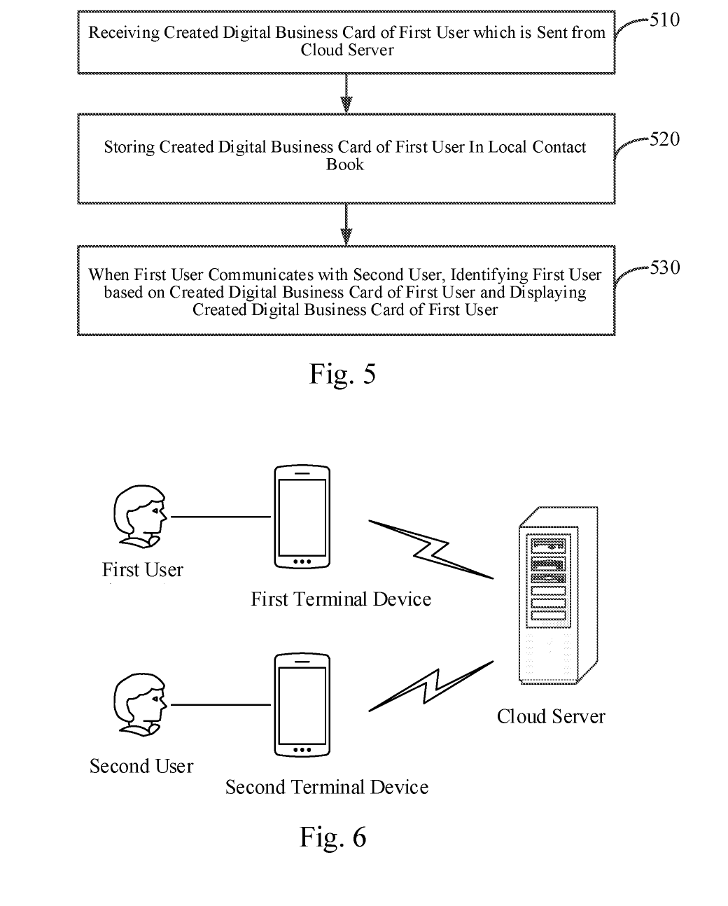

FIG. 5 is a flow chart illustrating another method for sharing a cloud-based business card according to an exemplary embodiment of the present disclosure, which is implemented by a second terminal device which is used by a second user. Based on the embodiment as shown in FIG. 4, the method includes the following steps.

In step 510, a created digital business card of the first user which is sent from the cloud server is received.

In the embodiment of the present disclosure, the first user can be a contact of the second user and the contact information of the first user is stored in a contact book application program installed in the second terminal device. If the first user creates his cloud-based digital business card in the cloud server, the cloud server can send the digital business card of the first user to the second terminal device corresponding to the second user and store the digital business card in the contact book application program of the second terminal device.

In step 520, the created digital business card of the first user is stored in a local contact book application program.

In step 530, when the first user communicates with the second user, the first user is identified based on the created digital business card of the first user and the created digital business card of the first user is displayed.

It can be seen from the above embodiment that, the second terminal device receives the created digital business card of the first user which is sent from the cloud server, and automatically stores the created digital business card of the first user in the local contact book application program of the second terminal device. When the first user communicates with the second user, the second terminal device can identify the first user based on the created digital business card of the first user and display the created digital business card of the first user. Thereby, the second user can automatically identify the first user based on the created digital business card of the first user. Thus, it can improve the speed and accuracy of the identification of the first user by the second user, and can improve the user experience for the second user.

FIG. 6 is a diagram illustrating an application scenario of a method for sharing a cloud-based business card according to an exemplary embodiment of the present disclosure. The application scenario involves a cloud server, a first terminal device and a second terminal device. Wherein, a first user uses the first terminal device and the second user uses the second terminal device.

The first terminal device acquires business card data of the first user to which the first terminal device corresponds, and the business card data carries a user identifer of the first user. The first terminal device sends the business card data to the cloud server. When the cloud server performs a search and searches out a digital business card of the first user according to the user identifer of the first user, the cloud server updates the digital business card of the first user with the received business card data of the first user, to obtain an updated digital business card of the first user. Then the cloud server sends the updated digital business card of the first user to the second terminal device which has stored the user identifer of the first user. The second terminal device updates the digital business card of the first user locally stored in the second terminal device. Then, when the first user communicates with the second user, the second terminal device can identify the first user based on the updated digital business card of the first user and display the updated cloud of the first user, such that the second user can identify the first user based on the updated digital business card of the first user. Thereby, the second user can identify the first user according to the updated digital business card of the first user more quickly, resulting in an improved user experience for the second user.

Corresponding to the method for sharing a cloud-based business card according to the above embodiments, the present disclosure also provides embodiments involving a device for sharing a cloud-based business card.

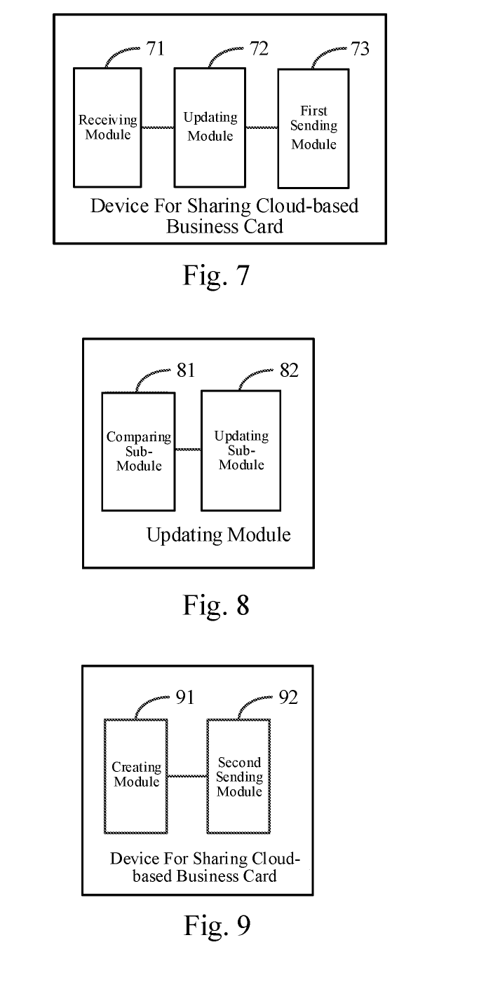

FIG. 7 is a block diagram illustrating a device for sharing a cloud-based business card according to an exemplary embodiment of the present disclosure, which is implemented by a cloud server, and configured to perform the method for sharing a cloud-based business card as shown in FIG. 1. The device includes: a receiving module 71, an updating module 72 and a first sending module 73.

The receiving module 71 is configured to receive business card data of a first user. Herein the business card data carries a user identifer of the first user.

The updating module 72 is configured to, perform a search to determine whether a digital business card of the first user has been stored in the cloud server by using the user identifer of the first user; and update the digital business card of the first user according to the business card data of the first user to obtain an updated digital business card of the first user in response to determing that a digital business card of the first user has been stored in the cloud server.

The first sending module 73 is configured to send the updated digital business card of the first user to a second terminal device which has stored the user identifer of the first user, such that when a second user communicates with the first user by utilizing the second terminal device, the second terminal device automatically displays the updated digital business card of the first user to make the second user identify the first user based on the updated digital business card of the first user.

FIG. 8 is a block diagram illustrating another device for sharing a cloud-based business card according to an exemplary embodiment of the present disclosure, which is implemented by a cloud server, and based on the embodiment as shown in FIG. 7, configured to perform the method for sharing a cloud-based business card as shown in FIG. 2. The business card data of the first user contains information corresponding to each item of the digital business card of the first user and a version number, and the updating module 72 can include: a comparing sub-module 81 and an updating sub-module 82.

The comparing sub-module 81 is configured to compare the received version number with a version number of a digital business card of the first user which is stored locally, to obtain a comparison result.

The updating sub-module 82 is configured to, when the comparison result indicates that the received business card data is a more recent version of the digital business card of the first user which is stored locally, update the digital business card of the first user which is stored locally with the received business card data to obtain the updated digital business card of the first user.

FIG. 9 is a block diagram illustrating another device for sharing a cloud-based business card according to an exemplary embodiment of the present disclosure, which is implemented by a cloud server, and based on the embodiment as shown in FIG. 7, configured to perform the method for sharing a cloud-based business card as shown in FIG. 3. The device can also include: a creating module 91 and a second sending module 92.

The creating module 91 is configured to, when no digital business card of the first user has been stored in the cloud server, create a digital business card of the first user according to the business card data of the first user, to obtain a created digital business card of the first user.

The second sending module 92 is configured to send the created digital business card of the first user to a second terminal device corresponding to a second terminal device which has stored the user identifer of the first user, such that when a second user communicates with the first user by utilizing the second terminal device, the second terminal device automatically displays the created digital business card of the first user to make the second user identify the first user based on the created digital business card of the first user.

In addition, in the above embodiment, the first user can communicate with the second user through at least one of the following communication manners: the first user calls the second user with an updated telephone number; the first user sends a short message to the second user with an updated telephone number; and the first user sends an email to the second user with an updated email address. Herein, the updated telephone number and the updated email address are contained in the business card data of the first user.

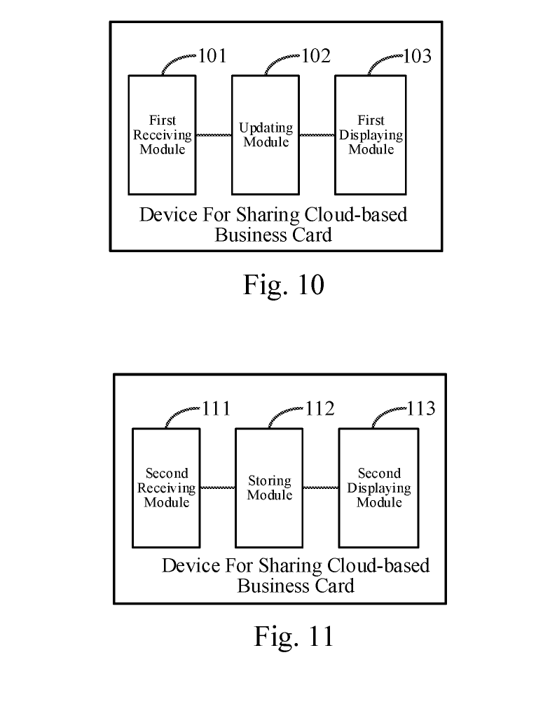

FIG. 10 is a block diagram illustrating another device for sharing a cloud-based business card according to an exemplary embodiment of the present disclosure, which is implemented by a second terminal device used by a second user, and configured to perform the method for sharing a cloud-based business card as shown in FIG. 4. The device can include: a first receiving module 101, an updating module 102 and a first displaying module 103.

The first receiving module 101 is configured to receive an updated digital business card of a first user which is sent from a cloud server.

The updating module 102 is configured to update a digital business card of the first user which is stored locally with the updated digital business card of the first user.

The first displaying module 103 is configured to, when the first user communicates with a second user which has stored a user identifer of the first user, identify the first user based on the updated digital business card of the first user and display the updated digital business card of the first user.

FIG. 11 is a block diagram illustrating another device for sharing a cloud-based business card according to an exemplary embodiment of the present disclosure, which is implemented by a second terminal device used by a second user, and configured to perform the method for sharing a cloud-based business card as shown in FIG. 5. The device can also include: a second receiving module 111, a storing module 112 and a second displaying module 113.

The second receiving module 111 is configured to receive a created digital business card of the first user which is sent from the cloud server.

The storing module 12 is configured to store the created digital business card of the first user in a local contact book application program.

The second displaying module 113 is configured to, when the first user communicates with the second user corresponding to the second terminal device, display the updated digital business card of the first user, such that the second user can identify the first user according to the updated digital business card of the first user.

Implementation of the functions and operations of the modules in the above devices can be specifically referred to the implementation of the corresponding steps in the above methods, which will not be repeated herein.

For the device embodiments, since they correspond to the method embodiments, they can be referred to the related part of the description of the method embodiments. The device embodiments described above are merely illustrative. The units described as separate may be or may not be physically separate, and the components illustrated as a units may be or may not be physical units, and may be at the same location, or may be distributed to multiple units over the network. A part of or all of the modules can be selected to achieve the objective of the present disclosure as desired. One skilled in the art can understand and practice the embodiments without paying creative labor.

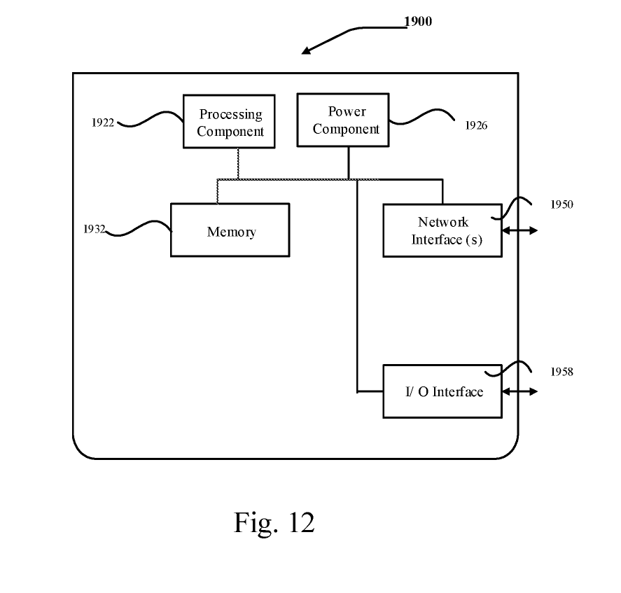

FIG. 12 is a block diagram illustrating another device 1900 (such as the cloud server) for sharing a cloud-based business card according to an exemplary embodiment of the present disclosure. For example, the device 1900 includes a processing component 1922 that further includes one or more processors, and memory resources represented by a memory 1932 for storing instructions executable by the processing component 1922, such as application programs. The application programs stored in the memory 1932 may include one or more modules each corresponding to a set of instructions. Further, the processing component 1922 is configured to execute the instructions.

The device 1900 may also include a power component 1926 configured to perform power management of the device 1900, wired or wireless network interface(s) 1950 configured to connect the device 1900 to a network, and an input/output (I/O) interface 1958. The device 1900 may operate based on an operating system stored in the memory 1932, such as Windows Server™, Mac OS X™, Unix™, Linux, FreeBSD™, or the like.

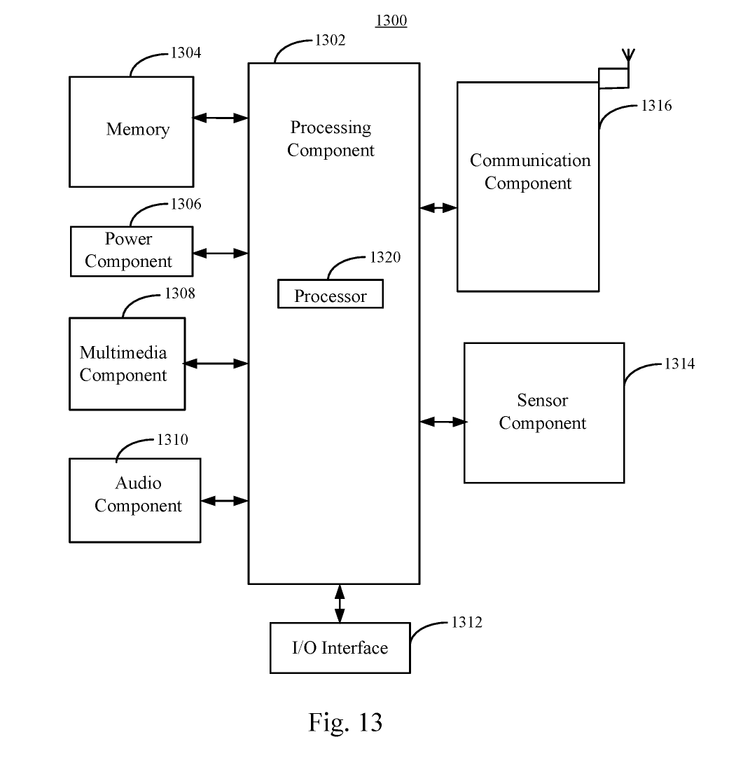

FIG. 13 is another block diagram illustrating another device 1300 (such as the second terminal device) for sharing a cloud-based business card according to an exemplary embodiment of the present disclosure. For example, the device 1300 may be a mobile phone with routing function, a computer, a digital broadcast terminal device, a messaging device, a gaming console, a tablet, a medical device, exercise equipment, a personal digital assistant, and the like.

Referring to FIG. 13, the device 1300 may include one or more of the following components: a processing component 1302, a memory 1304, a power component 1306, a multimedia component 1308, an audio component 1310, an input/output (I/O) interface 1312, a sensor component 1314, and a communication component 1316.

The processing component 1302 typically controls overall operations of the device 1300, such as the operations associated with display, telephone calls, data communications, camera operations, and recording operations. The processing component 1302 may include one or more processors 1320 to execute instructions to perform all or part of the steps in the above described methods. Moreover, the processing component 1302 may include one or more modules which facilitate the interaction between the processing component 1302 and other components. For instance, the processing component 1302 may include a multimedia module to facilitate the interaction between the multimedia component 1308 and the processing component 1302.

The memory 1304 is configured to store various types of data to support the operation of the device 1300. Examples of such data include instructions for any applications or methods operated on the device 1300, contact data, phonebook data, messages, pictures, video, etc. The memory 1304 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1306 provides power to various components of the device 1300. The power component 1306 may include a power management system, one or more power sources, and any other components associated with the generation, management, and distribution of power in the device 1300.

The multimedia component 1308 includes a screen providing an output interface between the device 1300 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1308 includes a front camera and/or a rear camera. The front camera and the rear camera may receive an external multimedia datum while the device 1300 is in an operation mode, such as a photographing mode or a video mode. Each of the front camera and the rear camera may be a fixed optical lens system or have focus and optical zoom capability.

The audio component 1310 is configured to output and/or input audio signals. For example, the audio component 1310 includes a microphone (“MIC”) configured to receive an external audio signal when the device 1300 is in an operation mode, such as a call mode, a recording mode, and a voice recognition mode. The received audio signal may be further stored in the memory 1304 or transmitted via the communication component 1316. In some embodiments, the audio component 1310 further includes a speaker to output audio signals.

The I/O interface 1312 provides an interface between the processing component 1302 and peripheral interface modules, such as a keyboard, a click wheel, buttons, and the like. The buttons may include, but are not limited to, a home button, a volume button, a starting button, and a locking button.

The sensor component 1314 includes one or more sensors to provide status assessments of various aspects of the device 1300. For instance, the sensor component 1314 may detect an open/closed status of the device 1300, relative positioning of components, e.g., the display and the keypad, of the device 1300, a change in position of the device 1300 or a component of the device 1300, a presence or absence of user contact with the device 1300, an orientation or an acceleration/deceleration of the device 1300, and a change in temperature of the device 1300. The sensor component 1314 may include a proximity sensor configured to detect the presence of nearby objects without any physical contact. The sensor component 1314 may also include a light sensor, such as a CMOS or CCD image sensor, for use in imaging applications. In some embodiments, the sensor component 1314 may also include an accelerometer sensor, a gyroscope sensor, a magnetic sensor, a pressure sensor, a microwave sensor or a temperature sensor.

The communication component 1316 is configured to facilitate communication, wired or wirelessly, between the device 1300 and other devices. The device 1300 can access a wireless network based on a communication standard, such as WiFi, 2G, or 3G, or a combination thereof. In one exemplary embodiment, the communication component 1316 receives a broadcast signal or broadcast associated information from an external broadcast management system via a broadcast channel. In one exemplary embodiment, the communication component 1316 further includes a near field communication (NFC) module to facilitate short-range communications. For example, the NFC module may be implemented based on a radio frequency identifer (RFID) technology, an infrared data association (IrDA) technology, an ultra-wideband (UWB) technology, a Bluetooth (BT) technology, and other technologies.

In exemplary embodiments, the device 1300 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1304, executable by the processor 1320 in the device 1300, for performing the above-described methods. For example, the non-transitory computer-readable storage medium may be a ROM, a RAM, a CD-ROM, a magnetic tape, a floppy disc, an optical data storage device, and the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for sharing a cloud-based business card, which is implemented by a cloud server, the method comprising:
receiving business card data of a first user from a first terminal device, the business card data carrying a user identifer of the first user;
performing a search to determine whether a digital business card of the first user has been stored in the cloud server by using the user identifer of the first user;
updating the digital business card of the first user according to the business card data of the first user to obtain an updated digital business card of the first user in response to determing that a digital business card of the first user has been stored in the cloud server; and
sending the updated digital business card of the first user to a second terminal device which has stored the user identifer of the first user, such that when a second user communicates with the first user by utilizing the second terminal device, the second terminal device automatically displays the updated digital business card of the first user to make the second user identify the first user based on the updated digital business card of the first user.

2. The method of claim 1, wherein the business card data of the first user contains information corresponding to each item of the digital business card of the first user and a version number, and updating the digital business card of the first user according to the business card data of the first user to obtain an updated digital business card of the first user comprises:
comparing the received version number with a version number of a digital business card of the first user which is stored locally, to obtain a comparison result; and
when the comparison result indicates that the received business card data is a more recent version of the digital business card of the first user which is stored locally, updating the digital business card of the first user which is stored locally with the received business card data to obtain the updated digital business card of the first user.

3. The method of claim 1, wherein the method further comprises:
when no digital business card of the first user has been stored in the cloud server, creating a digital business card of the first user according to the business card data of the first user, to obtain a created digital business card of the first user; and
sending the created digital business card of the first user to a second terminal device which has stored the user identifer of the first user, such that when the second user communicates with the first user by utilizing the second terminal device, the second terminal device automatically displays the created digital business card of the first user to make the second user identify the first user based on the created digital business card of the first user.

4. The method of claim 1, wherein the first user communicates with the second user through at least one of the following manners:
the first user calls the second user with an updated telephone number;
the first user sends a short message to the second user with an updated telephone number; and
the first user sends an email to the second user with an updated email address;
wherein the updated telephone number and the updated email address are contained in the business card data of the first user.

5. The method of claim 2, wherein the first user communicates with the second user through at least one of the following manners:
the first user calls the second user with an updated telephone number;
the first user sends a short message to the second user with an updated telephone number; and
the first user sends an email to the second user with an updated email address;
wherein the updated telephone number and the updated email address are contained in the business card data of the first user.

6. The method of claim 3, wherein the first user communicates with the second user through at least one of the following manners:
the first user calls the second user with an updated telephone number;
the first user sends a short message to the second user with an updated telephone number; and
the first user sends an email to the second user with an updated email address;
wherein the updated telephone number and the updated email address are contained in the business card data of the first user.

7. A cloud server for sharing a cloud-based business card, the cloud server comprising:
a processor; and
a memory for storing instructions executable by the processor;
wherein the processor is configured to perform:
receiving business card data of a first user from a first terminal device, the business card data carrying a user identifer of the first user;
performing a search to determine whether a digital business card of the first user has been stored in the cloud server by using the user identifer of the first user;
updating the digital business card of the first user according to the business card data of the first user to obtain an updated digital business card of the first user in response to determing that a digital business card of the first user has been stored in the cloud server; and
sending the updated digital business card of the first user to a second terminal device which has stored the user identifer of the first user, such that when a second user communicates with the first user by utilizing the second terminal device, the second terminal device automatically displays the updated digital business card of the first user to make the second user identify the first user based on the updated digital business card of the first user.

8. The cloud server of claim 7, wherein the business card data of the first user contains information corresponding to each item of the digital business card of the first user and a version number, and updating the digital business card of the first user according to the business card data of the first user to obtain an updated digital business card of the first user comprises:
comparing the received version number with a version number of a digital business card of the first user which is stored locally, to obtain a comparison result; and
when the comparison result indicates that the received business card data is a more recent version of the digital business card of the first user which is stored locally, updating the digital business card of the first user which is stored locally with the received business card data to obtain the updated digital business card of the first user.

9. The cloud server of claim 7, wherein the processor is further configured to perform:
when no digital business card of the first user has been stored in the cloud server, creating a digital business card of the first user according to the business card data of the first user, to obtain a created digital business card of the first user; and
sending the created digital business card of the first user to a second terminal device which has stored the user identifer of the first user, such that when the second user communicates with the first user by utilizing the second terminal device, the second terminal device automatically displays the created digital business card of the first user to make the second user identify the first user based on the created digital business card of the first user.

10. The cloud server of claim 7, wherein the first user communicates with the second user through at least one of the following manners:
the first user calls the second user with an updated telephone number;
the first user sends a short message to the second user with an updated telephone number; and
the first user sends an email to the second user with an updated email address;
wherein the updated telephone number and the updated email address are contained in the business card data of the first user.

11. The cloud server of claim 8, wherein the first user communicates with the second user through at least one of the following manners:
the first user calls the second user with an updated telephone number;
the first user sends a short message to the second user with an updated telephone number; and
the first user sends an email to the second user with an updated email address;
wherein the updated telephone number and the updated email address are contained in the business card data of the first user.

12. The cloud server of claim 9, wherein the first user communicates with the second user through at least one of the following manners:
the first user calls the second user with an updated telephone number;
the first user sends a short message to the second user with an updated telephone number; and
the first user sends an email to the second user with an updated email address;
wherein the updated telephone number and the updated email address are contained in the business card data of the first user.

13. A non-transitory computer-readable storage medium storing instructions that, when being executed by a processor of a cloud server, for performing a method for sharing a cloud-based business card, the method comprising:
receiving business card data of a first user from a first terminal device, the business card data carrying a user identifer of the first user;
performing a search to determine whether a digital business card of the first user has been stored in the cloud server by using the user identifer of the first user;
updating the digital business card of the first user according to the business card data of the first user to obtain an updated digital business card of the first user in response to determing that a digital business card of the first user has been stored in the cloud server; and
sending the updated digital business card of the first user to a second terminal device which has stored the user identifer of the first user, such that when a second user communicates with the first user by utilizing the second terminal device, the second terminal device automatically displays the updated digital business card of the first user to make the second user identify the first user based on the updated digital business card of the first user.

14. The non-transitory computer-readable storage medium of claim 13, wherein the business card data of the first user contains information corresponding to each item of the digital business card of the first user and a version number, and updating the digital business card of the first user according to the business card data of the first user to obtain an updated digital business card of the first user comprises:
comparing the received version number with a version number of a digital business card of the first user which is stored locally, to obtain a comparison result; and
when the comparison result indicates that the received business card data is a more recent version of the digital business card of the first user which is stored locally, updating the digital business card of the first user which is stored locally with the received business card data to obtain the updated digital business card of the first user.

15. The non-transitory computer-readable storage medium of claim 13, wherein the method further comprises:
when no digital business card of the first user has been stored in the cloud server, creating a digital business card of the first user according to the business card data of the first user, to obtain a created digital business card of the first user; and
sending the created digital business card of the first user to a second terminal device which has stored the user identifer of the first user, such that when the second user communicates with the first user by utilizing the second terminal device, the second terminal device automatically displays the created digital business card of the first user to make the second user identify the first user based on the created digital business card of the first user.

16. The non-transitory computer-readable storage medium of claim 13, wherein the first user communicates with the second user through at least one of the following manners:
the first user calls the second user with an updated telephone number;
the first user sends a short message to the second user with an updated telephone number; and
the first user sends an email to the second user with an updated email address;
wherein the updated telephone number and the updated email address are contained in the business card data of the first user.

17. The non-transitory computer-readable storage medium of claim 14, wherein the first user communicates with the second user through at least one of the following manners:
the first user calls the second user with an updated telephone number;
the first user sends a short message to the second user with an updated telephone number; and
the first user sends an email to the second user with an updated email address;
wherein the updated telephone number and the updated email address are contained in the business card data of the first user.

18. The non-transitory computer-readable storage medium of claim 15, wherein the first user communicates with the second user through at least one of the following manners:
the first user calls the second user with an updated telephone number;
the first user sends a short message to the second user with an updated telephone number; and
the first user sends an email to the second user with an updated email address;
wherein the updated telephone number and the updated email address are contained in the business card data of the first user.
